(19) United States
(12) Patent Application Publication
(10) Pub. No.: US 2010/0122017 A1
(43) Pub. Date: May 13, 2010

(54) MEMORY CONTROLLER, NON-VOLATILE MEMORY SYSTEM, AND HOST DEVICE

(76) Inventor: Masayuki Toyama, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/527,234

(22) PCT Filed: Mar. 13, 2008
(86) PCT No.: PCT/JP2008/000566

§ 371 Date: Aug. 14, 2009

(30) Foreign Application Priority Data
Mar. 28, 2007 (JP) 2007-083807

(51) Int. Cl. G06F 12/00; G06F 12/02; G06F 12/08

(52) U.S. Cl. 711/103; 711/115; 711/163; 711/206; 711/E12.001; 711/E12.008; 711/E12.091

(57) ABSTRACT

Provided is a nonvolatile memory system which can be used for a boot program storage and easily controlled by a host device. At the time of reading a boot code 201 from a flash memory 200, a memory controller 100 executes a first operation mode based on an instruction from a host device 300, and specifies a physical address of the flash memory 200 so that the boot code 201 is read from a specific area of the flash memory 200.

### TECHNICAL FIELD

The present invention relates to a memory controller for controlling a non-volatile memory, a non-volatile memory system consisting of the non-volatile memory and the memory controller, and a host device for accessing the non-volatile memory system.

### BACKGROUND ART

Devices handling digital information, such as personal computers, camcorders, cell phones, and hand-held music players (hereinafter, these devices are collectively referred to as “host devices”), use a non-volatile memory as a storage for holding digital information. Especially, NAND flash memories are characterized by large capacity and low cost, and because of such characteristics, they have been increasingly used as program storages not only for storing application programs but also boot programs.

In order to store a boot program into the NAND flash memory, thereby realizing boot from the flash memory, non-volatile memory systems including a cache for holding the boot program have been proposed (see, for example, Patent Document 1). However, such a conventional non-volatile memory system requires the host device to be provided with functions such as data rewriting, address management for managing defective blocks, and error correction. Therefore, the conventional non-volatile memory system has a problem where control within the host device is complicated.

Patent Document 1: Japanese Laid-Open Patent Publication No. 2004-220557

### DISCLOSURE OF THE INVENTION

### Problem To be Solved by the Invention

A prevalent application of the non-volatile memory is a non-volatile memory system detachable from a host device as in the case of the SD (Secure Digital) memory card. Such a non-volatile memory system includes a non-volatile memory and a controller, which controls the NAND flash memory. As a result, a logic device is realized which can be readily controlled by the host device.

In order for the host device to access the non-volatile memory system, it is necessary to perform a predetermined initialization process using driver software. However, at the time of start-up, the driver software has not yet been loaded into the host device, and therefore the initialization process cannot be performed. Accordingly, in the case of the conventional non-volatile memory system, even if the boot program is stored in the flash memory, the program cannot be read, so that the system cannot be utilized as a boot program storage without modification.

An objective of the present invention is to provide a non-volatile memory system which is capable of solving such a conventional problem, can be used as a boot program storage and can as well be readily controlled by a host device.

### Means for Solving the Problem

To achieve the objective as mentioned above, the present invention provides a memory controller for accessing a non-volatile memory in response to a request from a host device, the controller comprising:

system controller for specifying a physical address within the non-volatile memory in response to an instruction from the host device to set a first operating mode, and reading data from a specific area of the non-volatile memory;

a first interface for signal transmission/reception between the system controller and the host device; and

a second interface for signal transmission/reception between the system controller and the non-volatile memory.

Here, preferably, the system controller is capable of operating in two operating modes set by the host device, and when in a second operating mode different from the first operating mode, the system controller references an address conversion table to convert an access address specified by the host device into a physical address within the non-volatile memory and thereafter accesses the physical address obtained by the conversion.

Preferably, the system controller creates the address conversion table during or after operation in the first operating mode, and switches the mode to the second operating mode after the operation in the first operating mode.

Preferably, the first operating mode is made available by a first initialization process including a flash memory configuration process. Furthermore, the first initialization process is preferably performed after power on or reset.

Preferably, the second operating mode is made available by a second initialization process including a flash memory configuration process, a system configuration process, and creation of the address conversion table.

Preferably, the first operating mode is set by the host device issuing a predetermined command.

The memory controller according to the present invention may be such that the non-volatile memory holds a physical address of a specific area from which data is read in the first operating mode, and the system controller reads the physical address of the specific area in the first operating mode.

Here, preferably, the system controller further includes a mode switcher for switching between enabling and disabling of the first operating mode, and the system controller sets the first operating mode in accordance with a setting instruction from the host device when the first operating mode is enabled, and determines the setting instruction from the host device to be invalid access when the first operating mode is disabled.

The present invention also provides a non-volatile memory system comprising the memory controller and a non-volatile memory, and accessing the non-volatile memory in response to a request from the host device.

Here, preferably, the non-volatile memory system according to the present invention is detachable from the host device or mounted in the host device so as not to be detachable therefrom.

The present invention also provides a host device for accessing the non-volatile memory system to request data transfer, wherein,

the device accesses the non-volatile memory system in the first operating mode at the time of start-up, and after completion of the start-up, the device accesses the non-volatile memory system in the second operating mode.

### EFFECT OF THE INVENTION

In an operating mode (first operating mode) of the non-volatile memory system according to the present invention, the memory controller reads data from a specific area of the non-volatile memory without creating an address conversion table as required for a conventional operating mode (second operating mode).

As a result, the non-volatile memory system according to the present invention can be used as a boot program storage because a boot program stored in the non-volatile memory can be read even if driver software is not incorporated in the host device at the time of start-up. Furthermore, the non-volatile memory system according to the present invention is readily controlled by the host device.

### BRIEF DESCRIPTION OF THE DRAWINGS

FIG. 1 is a block diagram illustrating the configuration of a non-volatile memory system according to a first embodiment of the present invention, along with the configuration of a host device.

FIG. 2 is a state transition diagram for explaining the operation of a memory controller in FIG. 1.

FIG. 3 is a flowchart for explaining a first operating mode setting procedure and access in a first operating mode.

FIG. 4 is a flowchart for explaining a second operating mode setting procedure.

FIG. 5 is a diagram illustrating the configuration of an address conversion table.

FIG. 6 is a flowchart for explaining access in a second operating mode.

FIG. 7 is a block diagram illustrating the configuration of a non-volatile memory system according to a second embodiment of the present invention, along with the configuration of a host device.

FIG. 8 is a flowchart for explaining the first operating mode setting procedure and access in the first operating mode.

### BEST MODE FOR CARRYING OUT THE INVENTION

### First Embodiment

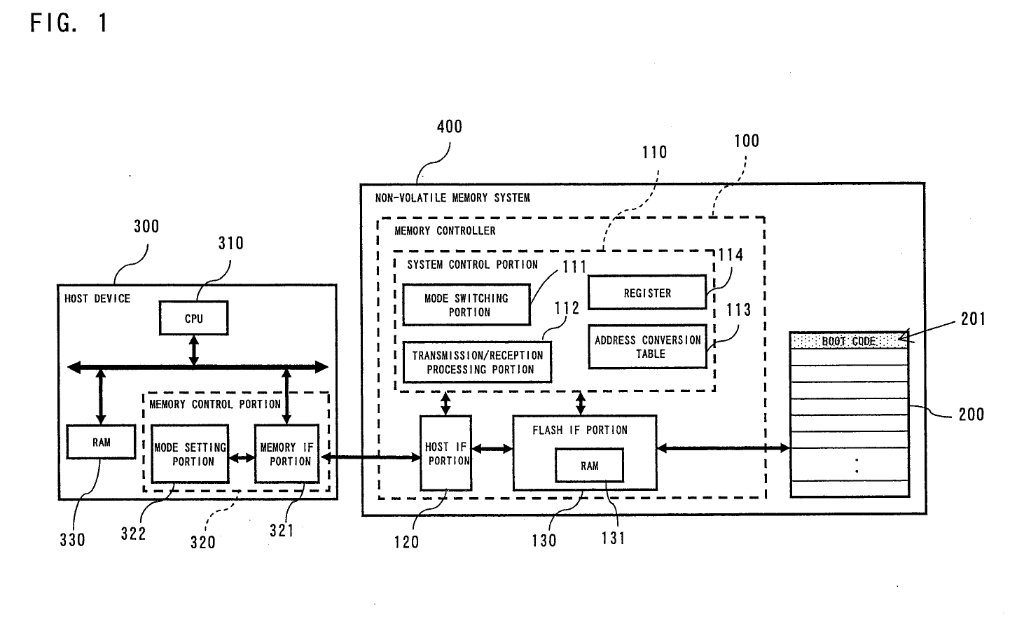

FIG. 1 illustrates the configuration of a non-volatile memory system including a memory controller according to a first embodiment of the present invention, along with the configuration of a host device for accessing the memory system.

The non-volatile memory system 400 consists of the memory controller 100 and a flash memory 200. The memory controller 100 is capable of accessing the flash memory 200 in either a first or second operating mode in accordance with an instruction from the host device 300.

In the first operating mode, the memory controller 100 reads a boot program from a specific area of the flash memory 200 in accordance with an instruction from the host device 300. In the second operating mode, the memory controller 100 reads/writes data from/to the flash memory 200 in accordance with an instruction from the host device 300.

The memory controller 100 includes a system control portion 110, a host IF portion 120, and a flash IF portion 130. The system control portion 110 controls writing/reading data to/from the flash memory 200, and also controls data transfer to/from the host device 300. The host IF portion 120 transmits/receives signals to/from the host device 300. The flash IF portion 130 transmits/receives signals to/from the flash memory 200. The flash IF portion 130 includes a RAM 131 for temporarily holding data.

The system control portion 110 includes a mode switching portion 111, a transmission/reception processing portion 112, an address conversion table 113, and a register 114. The mode switching portion 111 sets the operating mode of the memory controller 100 in accordance with an operating mode setting procedure by the host device 300. Note that the operating mode setting procedure will be described in detail later. Also, the mode switching portion 111 switches between enabling and disabling of the first one of the operating modes of the non-volatile memory system 400.

The transmission/reception processing portion 112 controls data transfer to the flash memory 200 in response to a request from the host device 300. The address conversion table 113 is a table for converting an access address transferred from the host device 300 into a physical address within the flash memory 200. The register 114 is used for detailed operational settings of the memory controller 100.

The flash memory 200 has a boot code 201 stored in an area to be read by the memory controller 100 in the first operating mode. The boot code 201 is a program for starting up the host device 300.

The host device 300 includes a CPU 310, a memory control portion 320, and a RAM 330. The CPU 310 controls a memory IF portion 321 and a mode setting portion 322, which are included in the memory control portion 320. The memory IF portion 321 transmits/receives signals to/from the non-volatile memory system 400. The mode setting portion 322 sets the operating mode of the non-volatile memory system 400. The RAM 330 temporarily holds data to be processed by the CPU 310.

Although not shown, the non-volatile memory system 400 is detachably loaded into the host device 300 via a slot provided in the host device 300. Accordingly, power consumed by the non-volatile memory system 400 is supplied from the host device 300 via a power supply line. Note that it is also possible to employ a form in which the non-volatile memory system 400 is mounted in the host device 300 and cannot be detached therefrom.

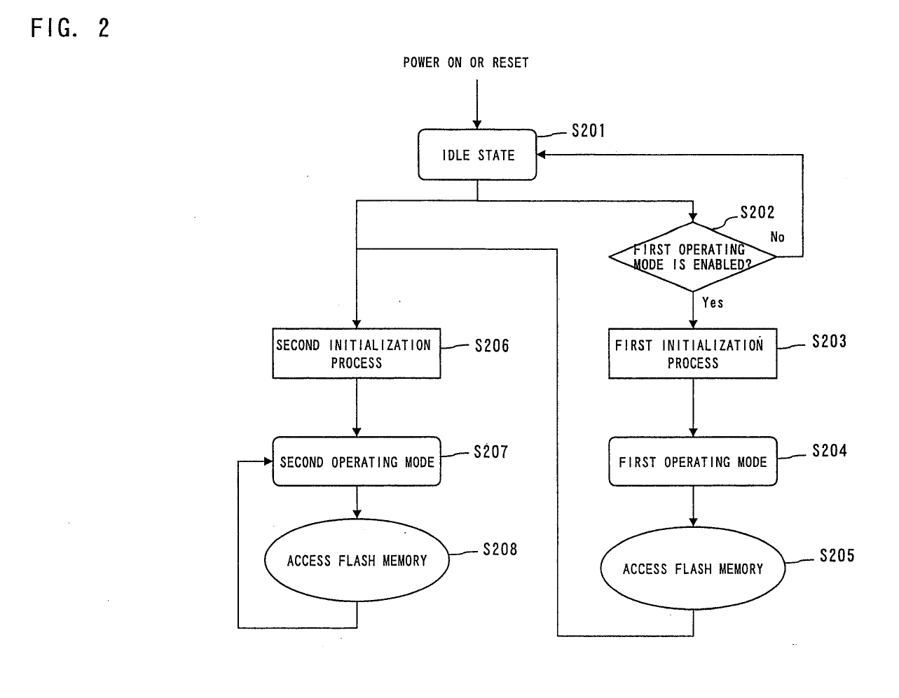

Next, the state transition of the memory controller 100 within the non-volatile memory system 400 will be described with reference to FIG. 2. As described above, the memory controller 100 is capable of accessing the flash memory 200 in either the first or second operating mode.

The non-volatile memory system 400 is brought into Idle state by power on or reset (step S201). In the Idle state (step S201), when the host device 300 sets the first operating mode, the mode switching portion 111 of the memory controller 100 checks whether the first operating mode is enabled (step S202).

Here, when the first operating mode is enabled, the memory controller 100 in the first operating mode can access a specific area of the flash memory 200 in which the boot code 201 is written. On the other hand, when the first operating mode is disabled (invalid), the flash memory 200 has no specific area in which the boot code 201 is written, or even if the flash memory 200 has a specific area in which the boot code 201 is written, the memory controller 100 cannot access the specific area in the first operating mode.

If the first operating mode is disabled (No) in step 5202, the memory controller 100 is brought back into the Idle state (step S201), or if enabled (Yes), the memory controller 100 subsequently performs a first initialization process (step S203). Thereafter, the memory controller 100 operates in the first operating mode (step S204). That is, the memory controller 100 accesses the flash memory 200 in the first operating mode (step S205). Subsequently, the memory controller 100 performs a second initialization process (step S206). Note that the first and second initialization processes will be described in detail later.

On the other hand, in the Idle state (step S201), when the host device 300 sets the second operating mode, the memory controller 100 performs the second initialization process (step S206). Thereafter, the memory controller 100 operates in the second operating mode (step S207). Specifically, the memory controller 100 accesses the flash memory 200 in response to a request from the host device 300 (step S208).

Hereinafter, the first and second operating modes will be individually described in detail with reference to the drawings, which will be followed at the end by the description of the relationship between the first and second operating modes.

First Operating Mode

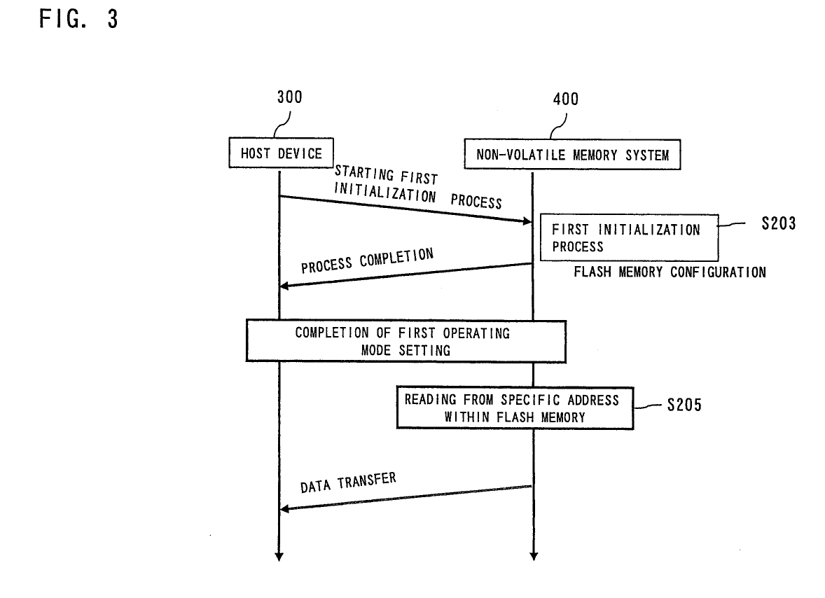

Described first is the first operating mode in which the host device 300 reads the boot code from the flash memory 200. FIG. 3 illustrates a specific process flow from the host device 300 setting the first operating mode during the Idle state (step 5201) in FIG. 2 to the memory controller 100 subsequently operating in the first operating mode (steps S203 to S205).

At the start-up, the host device 300 sets the mode setting portion 322 (FIG. 1) to the first operating mode, and issues a command requesting the non-volatile memory system 400 to start the first initialization process.

In response to the request by the host device 300 to start the first initialization process, the system control portion 110 executes the first initialization process (step S203). The first initialization process includes a flash memory configuration process. In the flash memory configuration process, the number and capacity of connected flash memories 200 are confirmed.

Upon completion of the first initialization process, the memory controller 100 notifies the host device 300 of the completion of the process, thereby completing the setting of the first operating mode. Subsequently, the non-volatile memory system 400 executes the process of step S205. Concretely, the system control portion 110 reads data for the boot code 201 (boot program) stored at a specific physical address within the flash memory 200, and transfers the data to the host device 300. At this time, the system control portion 110 may confirm whether or not there is any error in the data being read from the flash memory 200 based on an error correction code assigned to the data, or the system control portion 110 may transfer the data to the host device 300 without performing any error correction process.

Note that the system control portion 110 performs the second initialization process (step S206) during or after data reading in the first operating mode, and transitions to the second operating mode, as shown in FIG. 2 above.

As described above, the first operating mode is an operating mode exclusively intended for boot program reading, and the memory controller 100 reads the boot program from a specific area of the flash memory 200 in accordance with an instruction from the host device 300. In other words, even if the host device 300 does not have driver software for accessing the non-volatile memory system 400 loaded thereto at the start-up, by simply providing an instruction to set the operating mode, the host device can perform a start-up process by reading necessary data.

Second Operating Mode

Described next is the second operating mode for performing a basic function of the non-volatile memory system, i.e., data writing to/reception from the flash memory 200.

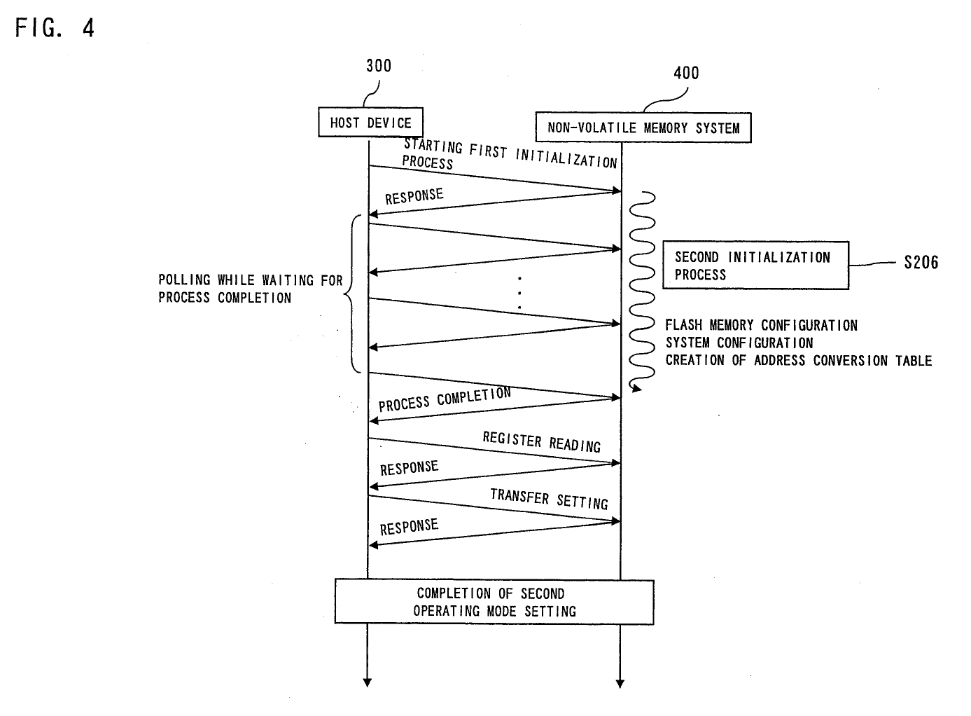

FIG. 4 illustrates the operating mode setting procedure (steps S206 and S207 in FIG. 2) after the start-up process in FIG. 2 (steps S201 to S205) and before the memory controller 100 operates in the second operating mode.

The host device 300 sets the mode setting portion 322 (FIG. 1) to the second operating mode, and accesses the non-volatile memory system 400 by handling it as a logic device. The host device 300 initially issues a command requesting the non-volatile memory system 400 to start the second initialization process. In the non-volatile memory system 400, the system control portion 110 executes the second initialization process (step S206), and provides a notification to the host device 300 when the process is completed.

The second initialization process (step S206) includes a system configuration process and creation of the address conversion table 113, in addition to the flash memory configuration process as included in the first initialization process. The flash memory configuration process is a process for confirming the number and capacity of connected flash memories 200, and the system configuration process is a process for reading system information from the flash memory 200.

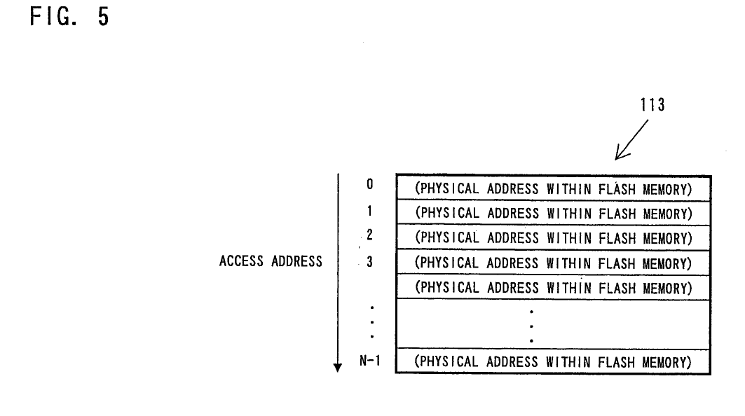

The creation of the address conversion table 113 in the second initialization process will be described with reference to the drawings. FIG. 5 illustrates the configuration of the address conversion table 113. The address conversion table 113 is a table for converting an access address from the host device 300 into a physical address within the flash memory 200, and the table stores physical addresses within the flash memory 200 as entries. The position of each entry in the table is uniquely determined based on the access address from the host device 300.

In the second initialization process (step S206), the system control portion 110 reads information for address conversion stored in a plurality of positions in the flash memory 200, and creates the address conversion table 113. Typically, this process takes a time period of hundreds of milliseconds, and therefore the host device 300 monitors a process completion notification by means of polling within that period.

Returning to FIG. 4, when the second initialization process (step S206) is completed, the host device 300 reads the register and performs a transfer setting before completing the second mode setting procedure. Here, the reading of the register is a process including checks as to the capacity and performance of the non-volatile memory system 400 and as to whether or not there is any additional function. Also, the transfer setting is a process including the setting of data width and operating frequency.

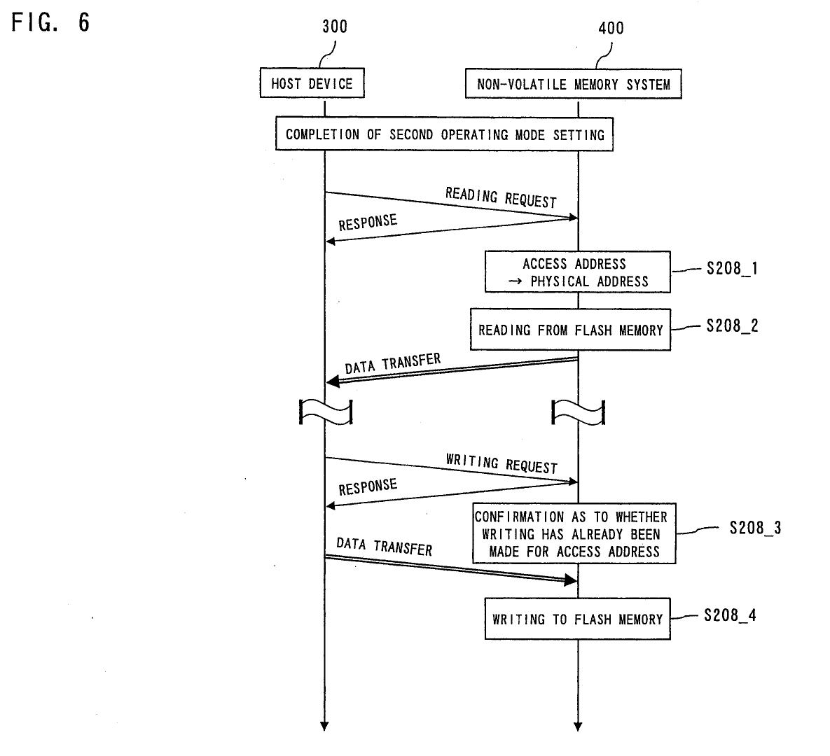

Next, accessing the flash memory 200 in the second operating mode as shown in step S208 of FIG. 2 will be described with reference to FIG. 6. When the second operating mode setting procedure is completed, the host device 300 requests the non-volatile memory system 400 to read or write data.

When the host device 300 requests the reading, the system control portion 110 in the non-volatile memory system 400 references the address conversion table 113 to convert an access address from the host device 300 into a physical address within the flash memory 200, as shown in step S208_1. Thereafter, the system control portion 110 reads data from an area specified by the physical address and transfers the data to the host device 300, as shown in step S208_2. At this time, the system control portion 110 also references an error correction code assigned to the data being read from the flash memory 200 to check whether or not there is any error in the data.

On the other hand, when the host device 300 requests the writing, the system control portion 110 in the non-volatile memory system 400 references the address conversion table 113 to check whether data has already been written at an access address from the host device 300, as shown in step S208_3. The memory controller 100 writes data to the flash memory 200 in accordance with the check result, as shown in step S208_4. At this time, the memory controller 100 writes the data with an error correction code being assigned thereto. Note that in step S208_4, an unillustrated data deleting or copying process may be performed instead of writing the data to the flash memory 200.

As described above, the second operating mode is an operating mode for realizing a basic function of the non-volatile memory system, and the memory controller 100 reads/writes data from/to the flash memory 200 in accordance with an instruction from the host device 200.

Specifically, the host device 300 can handle the non-volatile memory system 400 as a logic device regardless of the physical state of the flash memory 200, and therefore can have access for reading and writing with simple control procedures.

[Relationship Between First and Second Operating Modes]

In the first operating mode, the non-volatile memory system 400 can read data from the flash memory 200 in a short time. Accordingly, it is possible to realize a non-volatile memory system 400 suitable for storing a boot program to be read by the host device 300 immediately after its start-up.

On the other hand, as shown in FIG. 2 above, when data reading is completed in the first operating mode (steps S203 to S205), transition to the second operating mode occurs (steps S206 to S208). Thereafter, the host device 300 can handle the non-volatile memory system 400 as a logic device regardless of the physical state of the flash memory 200.

Specifically, the host device 300 sets the non-volatile memory system 400 to the first operating mode at the time of start-up to read the boot code 201 from the flash memory 200, and accesses the non-volatile memory system 400 in the second operating mode after completion of the start-up process. Accordingly, the non-volatile memory system 400 can be used not only as a storage for music/image data and the like but also as a storage for the boot code. Thus, it is possible to provide an easy-to-use non-volatile memory system.

While the present embodiment has been described with respect to the case of operations switching between the first and second operating modes, the present invention is not limited to this. For example, it is possible that the non-volatile memory system 400 operates only in the first operating mode, and is used as a memory system exclusively intended for boot code storage.

### Second Embodiment

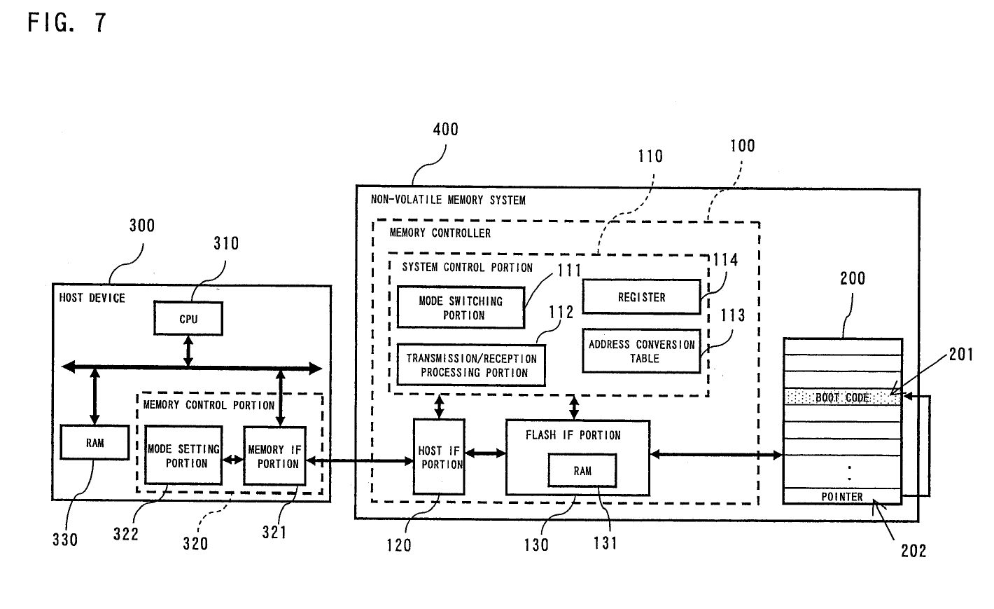

FIG. 7 illustrates the configuration of a non-volatile memory system including a memory controller according to a second embodiment of the present invention, along with the configuration of a host device for accessing the memory system.

The non-volatile memory system 400 and the host device 300 shown in FIG. 7 are equal in configuration to those shown in FIG. 1, but are different in terms of the method for storing data to the flash memory 200. Specifically, in addition to the boot code 201, the flash memory 200 has stored therein pointer information 202 indicating the position where the boot code 201 is stored.

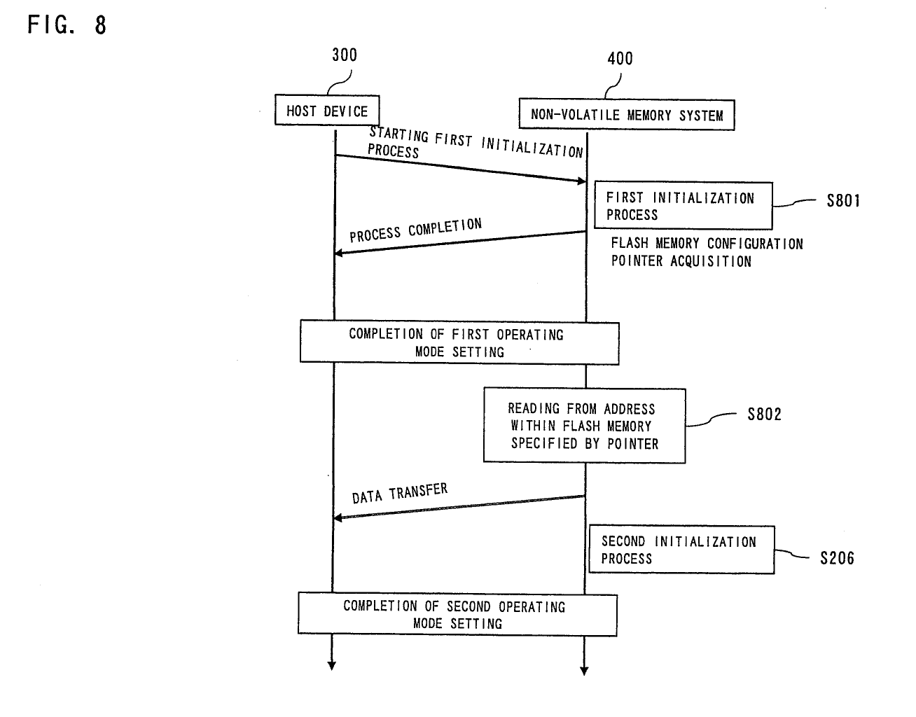

FIG. 8 illustrates a process flow where the host device 300 in the first operating mode accesses the flash memory 200 having stored therein the boot code 201 and the pointer information 202. When the host device 300 requests the non-volatile memory system 400 to start the first initialization process, the system control portion 110 in the non-volatile memory system 400 executes the first initialization process shown in step S801, and provides a notification to the host device 300 after the process is completed.

Here, the first initialization process in step S801 differs slightly from the first initialization process described in conjunction with step S203 of FIG. 3. Specifically, in step S203, the system control portion 110 reads the boot code 201 directly from a specific physical address within the flash memory 200. On the other hand, in step S801, the system control portion 110 references the pointer information 202 being read from the flash memory 200 to identify the position where the boot code 201 is stored, and thereafter reads the boot code 201 from the identified physical address.

In this manner, by acquiring from the pointer information the physical address of the data to be read, it becomes possible to read the boot code 201 in the first operating mode even if the boot code 201 is updated and stored to another address within the flash memory 200.

In FIG. 8, when the first operating mode setting procedure is completed, the system control portion 110 reads the boot code 201 from the flash memory 200 by referring to the pointer information 202 being read, as shown in step S802, and transfer it to the host device 300. Thereafter, as in the first embodiment, the system control portion 110 performs the second initialization process (step S206), and transitions to the second operating mode.

In the first embodiment, the flash memory 200 is used in read-only form, whereas in the present embodiment, it is used in rewritable form. Thus, in the present embodiment, it is possible to readily address situations where the boot code 201 is updated for upgrading the boot program.

While the foregoing description has been provided with respect to the best mode for carrying out the invention with reference to the drawings, the applicable scope of the invention is not limited to this, and it is apparent that the invention encompasses any mode obvious to those skilled in the art.

### INDUSTRIAL APPLICABILITY

The non-volatile memory system according to the present invention is useful as a semiconductor memory card or a program or data storage memory for a host device.

1. A memory controller for accessing a non-volatile memory in response to a request from a host device, the controller comprising:
system controller for specifying a physical address within the non-volatile memory in response to an instruction from the host device to set a first operating mode, and reading data from a specific area of the non-volatile memory;
a first interface for signal transmission/reception between the system controller and the host device; and
a second interface for signal transmission/reception between the system controller and the non-volatile memory.

2. The memory controller according to claim 1, wherein the system controller is capable of operating in two operating modes set by the host device, and when in a second operating mode different from the first operating mode, the system controller references an address conversion table to convert an access address specified by the host device into a physical address within the non-volatile memory and thereafter accesses the physical address obtained by the conversion.

3. The memory controller according to claim 2, wherein the system controller creates the address conversion table during or after operation in the first operating mode, and switches the mode to the second operating mode after the operation in the first operating mode.

4. The memory controller according to claim 2, wherein the first operating mode is made available by a first initialization process including a flash memory configuration process.

5. The memory controller according to claim 4, wherein the first initialization process is performed after power on or reset.

6. The memory controller according to claim 2, wherein the second operating mode is made available by a second initialization process including a flash memory configuration process, a system configuration process, and creation of the address conversion table.

7. The memory controller according to claim 2, wherein the first operating mode is set by the host device issuing a predetermined command.

8. The memory controller according to claim 2, wherein,
the non-volatile memory holds a physical address of a specific area from which data is read in the first operating mode, and
the system controller reads the physical address of the specific area in the first operating mode.

9. The memory controller according to claim 2, wherein,
the system controller further includes a mode switcher for switching between enabling and disabling of the first operating mode, and
the system controller sets the first operating mode in accordance with a setting instruction from the host device when the first operating mode is enabled, and determines the setting instruction from the host device to be invalid access when the first operating mode is disabled.

10. A non-volatile memory system comprising a memory controller of claim 1 and a non-volatile memory, and accessing the non-volatile memory in response to a request from the host device.

11. The non-volatile memory system according to claim 10, being detachable from the host device.

12. The non-volatile memory system according to claim 10, being mounted in the host device so as not to be detachable therefrom.

13. A host device for accessing the non-volatile memory system of claim 10 to request data transfer, wherein the device accesses the non-volatile memory system in the first operating mode at the time of start-up, and after completion of the start-up, the device accesses the non-volatile memory system in the second operating mode.

14. The host device according to claim 13, wherein the device reads a boot program from the non-volatile memory system in the first operating mode at the time of start-up.
